(19) United States
(12) Patent Application Publication
(10) Pub. No.: US 2021/0280351 A1
(43) Pub. Date: Sep. 9, 2021

(54) INDUCTIVE DEVICE

(71) Applicant: KONINKLIJKE PHILIPS N.V., Eindhoven (NL)

(72) Inventors: Bernd ACKERMANN, Aachen (DE); Albert GARCIA I TORMO, Eindhoven (NL); Peter LUERKENS, Aachen (DE)

(73) Assignee: Koninklijke Philips N.V., Eindhoven (NL)

(21) Appl. No.: 16/328,311

(22) PCT Filed: Aug. 28, 2017
(86) PCT No.: PCT/EP2017/071515

§ 371 Date: Feb. 26, 2019

(30) Foreign Application Priority Data
Aug. 29, 2016 (EP) 16186120.8

(51) Int. Cl. H01F 27/255; H01F 27/32; H01F 27/34; H01F 3/14

(52) U.S. Cl. CPC H01F 27/255; H01F 3/14; H01F 27/346; H01F 27/325

(57) ABSTRACT

High voltage DC generators based on a resonant tank include power inductors. As the demands on power output increase, but the demands on size of such high voltage DC generators decrease, the effect of radiated magnetic emissions become more significant. The present invention concerns a design for an inductive device, and a method for the assembly of an inductive device, in which a winding facing surface of the inductive device is a continuous portion, so that no air gap is present facing the winding facing surface. This reduces leakage of magnetic flux from the inductive device.

### FIELD OF THE INVENTION

This invention concerns an inductive device, and a method for producing an inductive device.

### BACKGROUND OF THE INVENTION

Power inductors are used in high demand applications, such as medical X-ray generators, where inductors with values of several μH, capable of handling hundreds of Amps are common. There is a trend towards the use of such inductors in applications with higher switching frequencies (around 500 kHz).

Such inductors frequently comprise two core halves. The core halves enclose a bobbin, upon which an inductive winding is wound. Typically, the core halves are separated by two or more air gaps. Such core halves may also be separated by an air gap with a small (almost negligible) distance between the two core halves, forming a mating surface between the two core halves. At such a mating surface, the surfaces of the two core halves have nearly identical cross sections, and are parallel to each other and in contact with each other.

Air gaps and mating surfaces, and especially misaligned core halves and mating surfaces can lead to the leakage of magnetic flux from an inductor. This causes an increase in losses in the core and windings of the inductor, and an increase in stray magnetic fields outside the inductor. The result is a detrimental consequence in terms of the Electromagnetic Interference (EMI) conformity of X-ray equipment.

US 2011/0121935 discusses an inductive device, but such devices can be further improved.

Further, KR 2015 0010315 A discloses another inductive device, applied to various power supply devices such as a discharge lamp. The inductor comprises a bobbin supporting a coil, wherein the bobbin is inserted in focusing cover. Such an inductor can be further improved at least with respect to stray magnetic fields outside the inductor.

Finally, US 2014/0176291 A1 discusses an inductive device, mainly used in electric vehicles. Therein, a bobbin supporting a coil is inserted into an outer core. The outer core has a quadrangular shape. Also, such a device can be further improved.

### SUMMARY OF THE INVENTION

According to a first aspect, there is provided an inductive device. The inductive device comprises:
an outer magnetic core arrangement formed from a first material; and
a winding support member having wound thereupon a winding having a first winding turn.

A winding facing surface of an inner surface of the outer magnetic core arrangement is defined as the inner surface of the outer magnetic core arrangement which faces the winding of the winding support member.

The outer magnetic core arrangement is configured such that any two arbitrary points on the winding facing surface are connectable via a straight construction line, wherein a path of the construction line does not intersect with other parts of the outer magnetic core arrangement.

The winding support member and the winding are enclosed within the outer magnetic core arrangement.

The winding facing surface of the outer magnetic core arrangement is a continuous portion of the first material of the outer magnetic core arrangement.

The area enclosed by the first winding turn defines a winding plane, and wherein a straight line perpendicular to the winding plane intersects the winding facing surface, such that, in operation, a magnetic field is substantially contained within the outer magnetic core arrangement.

The outer magnetic core arrangement is provided as a ring core, inside which the winding support member is arranged, with a centre axis of the winding support member being arranged so the ends of the winding support member face the inside surface of the outer magnetic core arrangement.

An effect of an inductive device according to the first aspect is that the combination of the alignment of the winding, and the alignment of the continuous portion of the first material of the outer magnetic core arrangement, means that no air gap is present in the winding facing surface. Thus, the leakage of stray magnetic fields from the outer magnetic core arrangement is reduced. In addition, misalignment of core halves during manufacture is also prevented.

Optionally, the outer magnetic core arrangement comprises at least two segments, wherein the segments comprise mating surfaces at a region of the outer magnetic core arrangement which does not comprise the winding facing surface, and wherein the mating surfaces are in alignment with a straight line perpendicular to the winding plane.

Thus, because mating surfaces in the outer magnetic material give rise to stray magnetic fields, a winding located away from such mating surfaces is less subject to such stray magnetic fields resulting in increased losses (proximity losses). Furthermore, the inductive device may be manufactured from modular components.

Optionally, the winding support member is a bobbin having a centre axis which is substantially aligned with the straight line perpendicular to the winding plane.

An effect of an inductive device according to the above option is that proximity losses are reduced to an optimum extent.

Optionally, the outer magnetic core arrangement comprises a first and a second separated core section arranged to contact each other at a mating surface.

Thus, the inductive device may be manufactured from modular components.

In an embodiment not according to the invention, the outer magnetic core arrangement may comprise two U-core halves.

Thus, the inductive device may be manufactured from freely-available modular components.

Optionally the outer magnetic core arrangement comprises two ring-core halves.

Thus, the inductive device may be manufactured from freely-available modular components.

Optionally, the winding support member comprises legs configured to support the outer magnetic core arrangement.

Optionally, the first material is a ferromagnetic material.

Optionally, the outer magnetic core arrangement is an integrally formed ring core.

Optionally, the internal volume of the winding support member entirely contains diamagnetic or paramagnetic material.

According to a second aspect, there is provided a method of manufacturing an inductive device. The method comprises:
a) providing an outer magnetic core arrangement formed from a first material;
   wherein the outer magnetic core arrangement is configured such that any two arbitrary points on the winding facing surface are connectable via a straight construction line, wherein a path of the construction line does not intersect with other parts of the outer magnetic core arrangement;
   wherein a winding facing surface of an inner surface of the outer magnetic core arrangement is defined as the inner surface of the outer magnetic core arrangement which faces the winding of the winding support member;
b) providing a winding support member having wound thereupon a winding having a first winding turn;
c) assembling the outer magnetic core arrangement and the winding support member such that the winding support member and the winding are enclosed within the outer magnetic core arrangement; and
d) providing the outer magnetic core arrangement as a ring core, inside which the winding support member is arranged, with a centre axis of the winding support member being arranged so the ends of the winding support member face the inside surface of the outer magnetic core arrangement.

The winding facing surface of the outer magnetic core arrangement is a continuous portion of the first material.

The area enclosed by the first winding turn defines a winding plane, and a straight line perpendicular to the winding plane intersects the winding facing surface, such that, in operation, a magnetic field is substantially contained within the outer magnetic core arrangement.

An effect of an inductive device according to the second aspect is that an inductive device can be produced in which the combination of the alignment of the winding, and the alignment of the continuous portion of the first material of the outer magnetic core arrangement, means that no air gap or mating surface is present in the winding facing surface. Thus, escape of stray magnetic fields from the outer magnetic core arrangement towards the winding is minimized. In addition, misalignment of core halves during manufacture is also prevented.

Optionally, the outer magnetic core arrangement comprises at least two segments, wherein the segments comprise mating surfaces at a region of the outer magnetic core arrangement which does not comprise the winding facing surface, and wherein the mating surfaces are in alignment with a straight line perpendicular to the winding plane.

An effect of this is that the inductive device may be manufactured from modular components whilst keeping the stray magnetic fields reaching the winding at a minimum.

Optionally, the outer magnetic core arrangement comprises two ring-core halves.

Optionally, the winding support member is a bobbin having a centre axis which is substantially aligned with the straight line perpendicular to the winding plane.

Optionally, the outer magnetic core arrangement is an integrally formed ring core.

In this specification, the term “outer magnetic core arrangement” refers to a member which surrounds an inductive coil arrangement, functioning to provide a magnetic circuit for magnetic flux generated by an inductor coil.

In this specification, the term “winding support member” refers to a member capable of supporting a wire winding, such as a litz wire winding. Commonly, a bobbin-shaped member is used, although the use of a cylinder with no terminal projections is also possible. Provided the winding support member is capable of supporting a wire winding, no particular restriction on shape is envisaged, and the winding support member may, for example, have a round cross-section, a square cross-section, or even a pentagonal or hexagonal cross section.

In this specification, the term “winding plane” refers to a plane which is parallel to the average alignment of a single wire turn of the winding held on the winding support member.

In this specification, the term “straight construction line” does not refer to a physical feature present in the structure of the inductive device according to the aspects described. Rather, this term must be read in context with the phrase “two arbitrary points on the winding facing surface are connectable via a straight construction line”. In other words, the winding facing surface itself is shaped to meet the constraint imposed that it must be possible, in any drawn view of the inductive device, to be able to draw a straight construction line between arbitrary points on the winding facing surface without that line interfering with other parts of the outer magnetic core arrangement.

In this specification, the term “continuous portion” refers to a section of material, such as soft ferrite core, which does not have an air gap or mating surface.

Therefore, it can be seen as a basic idea behind the invention to provide an inductive device in which an air gap or mating surface is not present in the immediate vicinity facing a winding of an inductive device, to reduce electromagnetic emissions from the inductive device.

### BRIEF DESCRIPTION OF THE DRAWINGS

The drawings are only for purposes of illustrating the preferred embodiments and are not to be construed as limiting the invention.

FIG. 1a) shows a side section view of a conventional power inductor.

FIG. 1b) shows a side view section of another conventional power inductor with its centre leg removed.

FIG. 2 shows a side section schematic view of a misaligned conventional power inductor.

FIG. 3 shows a side section schematic view of an inductor according to embodiments of the present invention.

FIG. 4 shows a detailed side section view of an inductor according to an example.

FIG. 5 shows a detailed side section view of an inductor according to an example.

FIG. 6 shows a side section schematic view of an inductor according to embodiments of the present invention.

FIG. 7 shows a flowchart of a method according to the second aspect.

FIG. 8a) shows a pre-assembly view of an embodiment of the present invention.

FIG. 8b) shows a post-assembly view of an embodiment of the present invention.

### DETAILED DESCRIPTION OF EMBODIMENTS

In high voltage applications, for example, X-ray source power supplies, power inductors are used in different places in the circuitry connected to the low-voltage side of the high-voltage transformer. For example, a resonant tank of a series resonant converter uses such inductors. As the operating frequencies and operating power of such inductive devices increases, greater constraints are placed on the designer of such equipment.

Power inductors are typically assembled from a wire coil which has been wound onto a bobbin. This arrangement is contained by an outer core section, typically made from a ferrite material.

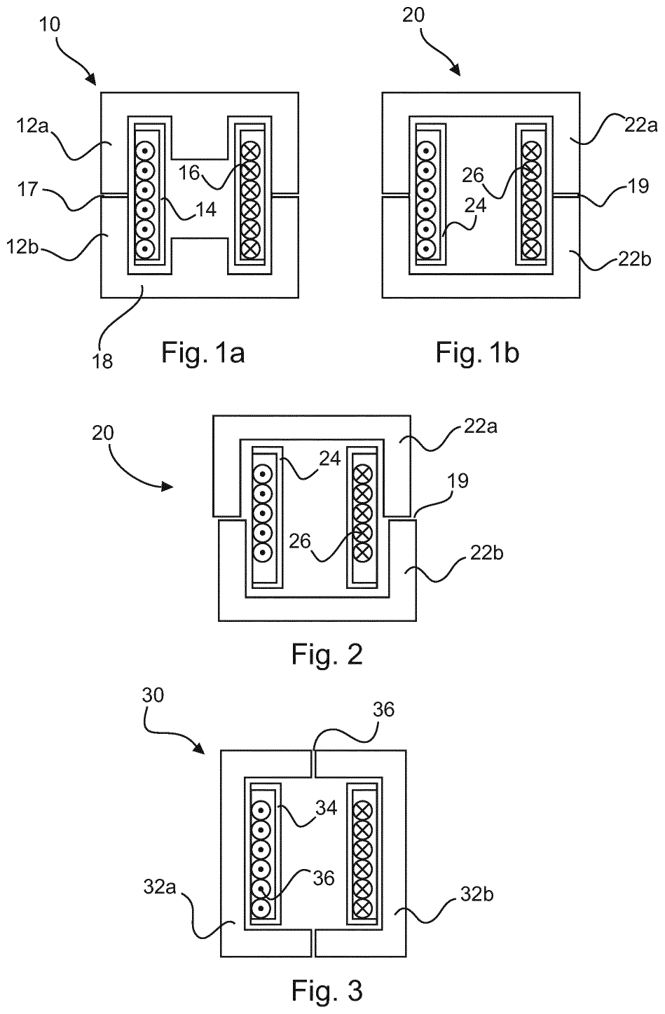

FIG. 1a) shows a side cut-through view of a design concept which is widely used for such inductors. The inductor 10 of FIG. 1a) comprises facing core halves 12a and 12b, in the form of two “E-cores” surrounding a bobbin 14. The core halves 12a and 12b are typically made from a soft ferrite material. An outer air gap 17 is thus present facing the inductive coil 16. Wound onto the bobbin is an inductive coil 16, typically made of copper wire or Litz wire, comprised of a plurality of wire turns around the bobbin. The inductor of FIG. 1a) also has top and bottom centre legs extending partially into the void inside the bobbin. Due to the high-current flowing in a high-power inductor, air-gaps such as air gap 17 can become large, relative to the rest of the inductor, in an optimized inductor design.

FIG. 1b) shows a side cut-through view of a variant of the conventional design, in which the void inside the bobbin has been enlarged to its maximum extent by complete removal of the centre leg through the use of “U” core halves 22a and 22b, having an air gap 19 and having a bobbin 24 comprising a winding 26 arranged on it. This design retains the outer air gap 19 resulting from the mating faces of two separate core haves 22a and 22b being pushed together. This approach allows simple “U” core halves 22a and 22b to be used.

In such a design, the air gap 19 in the two outer legs of the inductor 20 enables stray magnetic fields to form, outside the inductor, in the vicinity of the air gaps. This has a detrimental effect on the magnetic interference performance of such an inductor. Good magnetic interference performance is important in view of recent trends to make power supplies more compact, because components which cause magnetic interference, and components which are affected by magnetic interference, are placed much closer together. As a consequence of the air gaps 17 and 19 in the conventional designs, losses in the core, and magnetic stray fields outside the inductor will increase, requiring significant tolerances to be built into the design of such inductors.

FIG. 2 shows a side cut-through view of the variant of the conventional design depicted in FIG. 1b), where the two “U” core halves are misaligned.

According to an aspect, there is provided an inductive device 30.

FIG. 3 illustrates a side section schematic view of an inductive device 30 according to a first aspect.

The inductive device 30 according to the first aspect comprises:
an outer magnetic core arrangement 32a, 32b formed from a first material; and
a winding support member 34 having wound thereupon a winding 36 having a first winding turn.

A winding facing surface of an inner surface of the outer magnetic core arrangement 32a, 32b is defined as the inner surface of the outer magnetic core arrangement 32a, 32b which faces the winding 36 of the winding support member 34.

The outer magnetic core arrangement 32a, 32b is configured such that any two arbitrary points on the winding facing surface are connectable via a straight construction line, wherein a path of the construction line does not intersect with other parts of the outer magnetic core arrangement.

The winding support member 34 and the winding 36 are enclosed within the outer magnetic core arrangement 32a, 32b.

The winding facing surface of the outer magnetic core arrangement 32a, 32b is a continuous portion of the first material of the outer magnetic core arrangement 32a, 32b.

The area enclosed by the first winding turn defines a winding plane, and wherein a straight line perpendicular to the winding plane intersects the winding facing surface, such that, in operation, a magnetic field is substantially contained within the outer magnetic core arrangement.

The exemplary inductive device 30 illustrated in FIG. 3 is built using “U” core halves 32a and 32b, typically made from soft ferrite, which have an air gap 36 arranged substantially in alignment of the end to end axis (centre axis) of bobbin 34. In other words, the air gap in the inductive device 30 does not face the winding 36 held on the winding support member 34. This means that the magnetic field emissions external to the inductor generated by the winding 36 are significantly reduced, because the winding facing surface comprises a continuous portion of ferrite material. In addition, if alignment errors do occur, they are less likely to result in a degradation in electromagnetic emissions performance of the inductive device, because the winding facing surface does not face an air gap. Inductance tolerances due to misalignment of the core halves is significantly reduced.

In an example, the outer magnetic core arrangement 32a, 32b is comprised from two “U”-core halves. The winding support member 34 may, for example, be a bobbin around which the winding 36 is wound.

Support means to support the winding support member 34 and the outer magnetic core arrangement 32a, 32b may be provided. Alternatively, a dedicated bobbin can be used that also acts as a support member for the outer magnetic core arrangement 32a, 32b.

According to an embodiment, the air gaps of the outer magnetic core arrangement 32a, 32b are substantially in alignment with a centre axis of the winding support member 34. In this case, the centre-axis of the winding support member 34 is taken to be a construction line running perpendicular to a plane defined by a single wire turn of the winding 36 substantially in the geometrical centre of the winding support member 34.

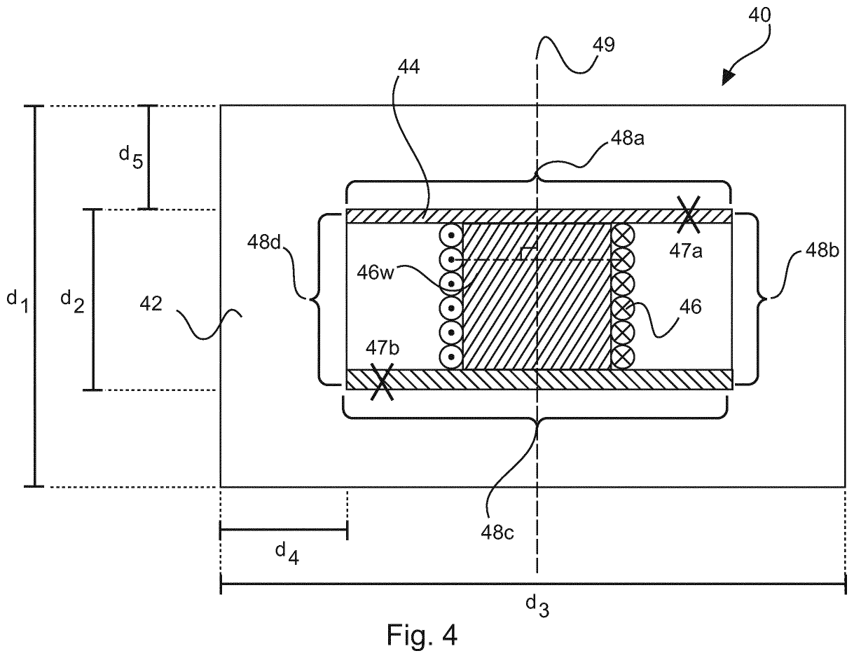

FIG. 4 illustrates a detailed side section view of a practical example of an inductive device 40 according to the first aspect. Exemplary operating conditions for such an inductive device would, for example, be a 500 kHz operating frequency, providing power in excess of 10 kW for pulses having a duration of several seconds.

The inductive device 40 comprises a plastic bobbin 44 which supports a ferrite core piece 42. The overall length d₃ of the ferrite core pieces 42 is 93 mm, and the overall length d₂ of the plastic bobbin 44 is 46 mm. The height d₄ and width d₅ of the ferrite core legs is 16 mm. Thus, the overall height d₁ of the assembled inductor is, thus, 78 mm. The winding 46 comprises a fully wound single layer of 6 turns of Litz wire. Typically, wire diameters between 3 and 4 mm are chosen.

Thus, the inductive device 40 has inner surfaces which face the winding 46. These inner surfaces are winding facing surfaces 48a, 48b, 48c, and 48d. The shape of the outer magnetic core arrangement 42 satisfies the following condition. Arbitrary points 47ₐ and 47_{b} present on the boundary of the winding facing surfaces may be connected by a straight construction line (not shown) across the void formed by the inner surfaces of the ferrite core piece 42, without such a construction line contacting (in the graphical projection) another part of the magnetic core arrangement 42.

The construction line 46w is a side-view of a plane formed by one winding turn of the winding 16. Construction line 49 shows a straight line perpendicular to such a winding plane 46w intersecting the winding facing surfaces 48a, 48c. In other words, such an orientation of the winding 46, in combination with the absence of an air gap in the winding facing surface, means that magnetic flux leakage from the winding (when the winding is energised) to areas outside of the outer magnetic core arrangement 42 is significantly reduced.

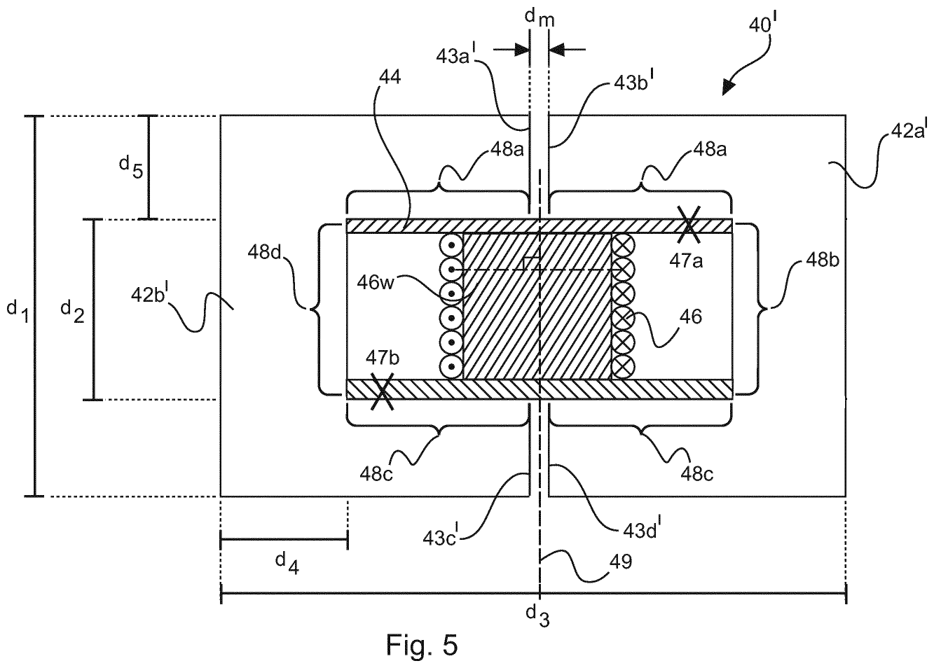

FIG. 5 shows a detailed side section view of another exemplary inductive device 40′. In this case, inductive device 40′ is of a similar design to that of the inductive device shown in FIG. 4, for which reference numerals referring to parts identical to parts in FIG. 4 are the same. In this example, the outer magnetic core arrangement is of a “U-core” type having a first U-core section 42a′ and a second U-core section 42b′. The first U-core section 42a′ and second U-core section 42b′ are arranged to face each other across mating surfaces 43a′ and 43b′, and 43c′ and 43d′. In FIG. 5, a distance dₘ between the mating surfaces 43a′ and 43b′ is shown. In practice, when assembled, this distance is so small as to be negligible (on the order of fractions of a millimetre). A line 49 perpendicular to the winding plane is shown in alignment to the mating surfaces. Thus, in this embodiment, the outer magnetic core arrangement 42a′ and 42b′ comprises at least two segments, wherein the segments comprise mating surfaces at a region of the outer magnetic core arrangement which does not comprise the winding facing surface, and wherein the mating surfaces are in alignment with a straight line perpendicular to the winding plane.

Of course, many different types of core design are available, and the disclosed concept also extends to inductors fabricated from “ring cores”.

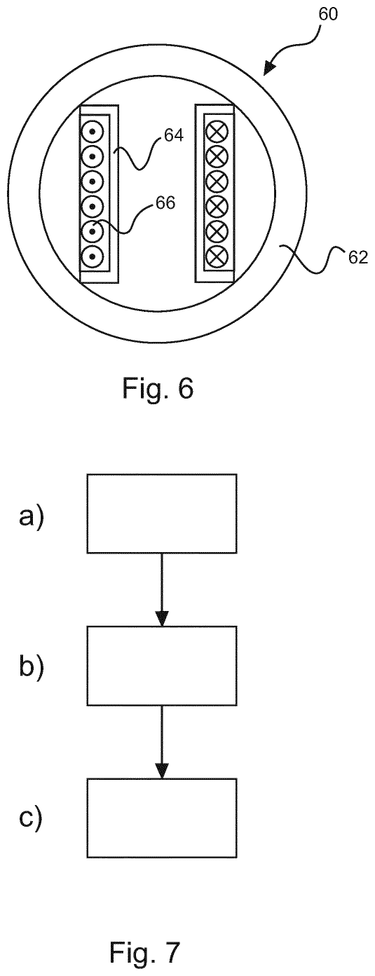

FIG. 6 demonstrates a schematic section view of an alternative inductor design concept according to the first aspect. The inductor 60 comprises an outer magnetic core arrangement 62 provided as a ring core, inside which the winding support member 64 (a bobbin) has been arranged, with the centre axis of the winding support member 64 being arranged so the ends of the winding support member 64 face the inside surface of the outer magnetic core arrangement 62. In an embodiment, the outer magnetic core arrangement 62 may optionally be made from two ring core halves. In this case, the air gap formed by joining the ring core halves is aligned so that the winding 66 does not face the air gap.

In other words, the winding 66 and the bobbin 64 of the design of FIG. 6 are placed, inside a ring core, in such a way that the magnetic field generated by the winding in operation is substantially perpendicular to the symmetry axis of the core.

Thus, magnetic stray fluxes outside the inductor 60 due to air gaps in the outer legs are significantly reduced. Increased core losses due to misalignment of core halves are also significantly reduced. Inductive tolerances due to misalignment of the core halves are significantly improved.

Of course, the ring core could also be shaped as a square-sectioned tube, or a rectangular sectioned tube. It is not essential that a cylindrical cross-section is used, and tubes of arbitrary cross sections could be used to house the winding support member.

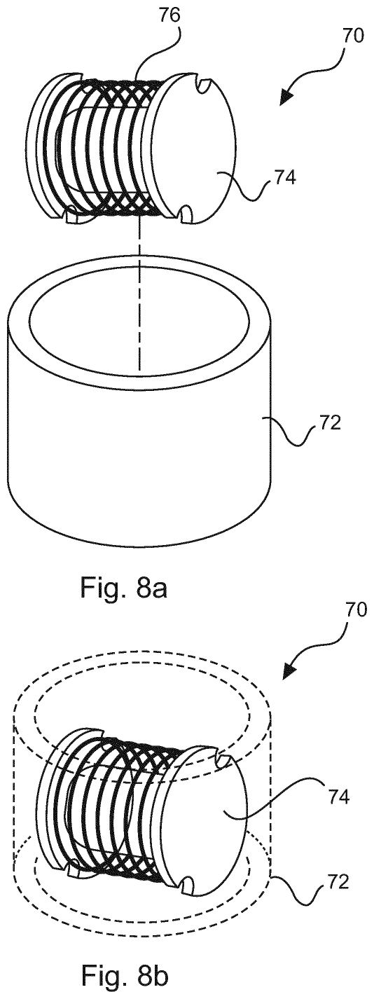

FIG. 8a) shows a 3D view of a pre-assembly stage of an inductive device 70, where the inductive device 70 is formed from a cylindrically shaped ferrite ring core 72 according to the previous example. The bobbin 74 supporting the winding 76 is arranged with its ends aligned transversely to the cylinder's principal axis.

FIG. 8b) shows a 3D view of an inductive device 70 following assembly, with the bobbin 74 supporting the winding 76 being held completely inside the inside of the cylindrically shaped ferrite ring core 72. It will be noted that, because the inside of the ring core is circular, two arbitrary points on the inside surface of the cylindrically shaped ferrite ring core 72 are connectable via a straight construction line, wherein a path of the construction line does not intersect with other parts of the outer magnetic core arrangement.

The area enclosed by a first winding turn of the winding 76 defines a winding plane. A straight line perpendicular to the winding plane intersects the winding facing surface, such that, in operation, a magnetic field is substantially contained within the outer magnetic core arrangement.

According to a second aspect, there is provided a method of manufacturing an inductive device. The method comprises:
a) providing an outer magnetic core arrangement formed from a first material;
   wherein a winding facing surface of an inner surface of the outer magnetic core arrangement is defined as the inner surface of the outer magnetic core arrangement which faces the winding of the winding support member;
   wherein the outer magnetic core arrangement is configured such that any two arbitrary points on the winding facing surface are connectable via a straight construction line, wherein a path of the construction line does not intersect with other parts of the outer magnetic core arrangement;
b) providing a winding support member having wound thereupon a winding having a first winding turn; and
c) assembling the outer magnetic core arrangement and the winding support member such that the winding support member and the winding are enclosed within the outer magnetic core arrangement,
   wherein the winding facing surface of the outer magnetic core arrangement is a continuous portion of the first material; and
   wherein the area enclosed by the first winding turn defines a winding plane, and wherein a straight line perpendicular to the winding plane intersects the winding facing surface, such that, in operation, a magnetic field is substantially contained within the outer magnetic core arrangement.

FIG. 7 illustrates the method according to the second aspect.

According to an embodiment, the outer magnetic core arrangement comprises at least two segments, wherein the segments comprise mating surfaces at a region of the outer magnetic core arrangement which does not comprise the winding facing surface, and wherein the mating surfaces are in alignment with a straight line perpendicular to the winding plane.

According to an embodiment, the outer magnetic core arrangement comprises two ring-core halves.

According to an embodiment, the winding support member is a bobbin having a centre axis which is substantially aligned with the straight line perpendicular to the winding plane.

According to an embodiment, the outer magnetic core arrangement comprises an integrally formed ring core.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. An inductive device, comprising:
an outer magnetic core arrangement formed from a first material;
a winding support member having wound thereupon a winding having a first winding turn;
wherein winding facing surfaces of an inner surface of the outer magnetic core arrangement are defined as the inner surfaces of the outer magnetic core arrangement which face the winding of the winding support member;
wherein the outer magnetic core arrangement is configured such that any two arbitrary points on the winding facing surface are connectable via a straight construction line, wherein a path of the construction line does not intersect with other parts of the outer magnetic core arrangement;
wherein the winding support member and the winding are enclosed within the outer magnetic core arrangement;
wherein the respective winding facing surface of the outer magnetic core arrangement is a continuous portion of the first material of the outer magnetic core arrangement;
wherein the area enclosed by the first winding turn defines a winding plane, and wherein a straight line perpendicular to the winding plane intersects the winding facing surface, such that, in operation, a magnetic field is substantially contained within the outer magnetic core arrangement; and
wherein the outer magnetic core arrangement is provided as a ring core, inside which the winding support member is arranged, with a center axis of the winding support member being arranged so the ends of the winding support member face the inside surface of the outer magnetic core arrangement.

2. The inductive device according to claim 1, wherein outer magnetic core arrangement comprises at least two segments, wherein the segments comprise mating surfaces at a region of the outer magnetic core arrangement which does not comprise the winding facing surface, and wherein the mating surfaces are in alignment with a straight line perpendicular to the winding plane.

3. The inductive device according to claim 1, wherein the winding support member is a bobbin having a centre axis which is substantially aligned with the straight line perpendicular to the winding plane.

4. The inductive device according to claim 1, wherein the outer magnetic core arrangement comprises a first and a second separated core section arranged to contact each other at a mating surface.

5. The inductive device according to claim 4, wherein the outer magnetic core arrangement comprises two ring-core halves.

6. The inductive device according to claim 1, wherein the winding support member comprises legs configured to support the outer magnetic core arrangement.

7. The inductive device according to claim 1, wherein the outer magnetic core arrangement is an integrally formed ring core.

8. The inductive device according to claim 1, wherein the first material is a ferromagnetic material.

9. The inductive device according to claim 1, wherein the internal volume of the winding support member entirely contains diamagnetic or paramagnetic material.

10. The inductive device according to claim 1, wherein the winding support member is arranged with its ends aligned transversely to a cylinder's principal axis of the outer magnetic core arrangement.

11. A method of manufacturing an inductive device, comprising:
providing an outer magnetic core arrangement formed from a first material;
wherein a winding facing surface of an inner surface of the outer magnetic core arrangement is defined as the inner surface of the outer magnetic core arrangement which faces the winding of the winding support member;
wherein the outer magnetic core arrangement is configured such that any two arbitrary points on the winding facing surface are connectable via a straight construction line, wherein a path of the construction line does not intersect with other parts of the outer magnetic core arrangement;
providing a winding support member having wound thereupon a winding having a first winding turn; and
assembling the outer magnetic core arrangement and the winding support member such that the winding support member and the winding are enclosed within the outer magnetic core arrangement,
wherein the winding facing surface of the outer magnetic core arrangement is a continuous portion of the first material;
wherein the area enclosed by the first winding turn defines a winding plane, and wherein a straight line perpendicular to the winding plane intersects the winding facing surface, such that, in operation, a magnetic field is substantially contained within the outer magnetic core arrangement;
providing the outer magnetic core arrangement as a ring core, inside which the winding support member is arranged, with a center axis of the winding support member being arranged so the ends of the winding support member face the inside surface of the outer magnetic core arrangement.

12. The method of claim 11, wherein the outer magnetic core arrangement comprises at least two segments, wherein the segments comprise mating surfaces at a region of the outer magnetic core arrangement which does not comprise the winding facing surface, and wherein the mating surfaces are in alignment with a straight line perpendicular to the winding plane.

13. The method of claim 11, wherein the outer magnetic core arrangement comprises two ring-core halves.

14. The method of claim 11, wherein the winding support member is a bobbin having a centre axis which is substantially aligned with the straight line perpendicular to the winding plane.

15. The method of claims 11, wherein the outer magnetic core arrangement comprises an integrally formed ring core.
